(19) United States
(12) Patent Application Publication
(10) Pub. No.: US 2019/0202703 A1
(43) Pub. Date: Jul. 4, 2019

(54) Molecular sieve, sound absorbing material using the same, and speaker

(71) Applicant: AAC Technologies Pte. Ltd., Singapore city (SG)

(72) Inventors: Yuan Gao, Shenzhen (CN); Xuan Kang, Shenzhen (CN); Jianchuan Li, Shenzhen (CN); Fateng Zhang, Shenzhen (CN); Ning Kang, Shenzhen (CN); Hao Liu, Shenzhen (CN)

(21) Appl. No.: 16/236,336

(22) Filed: Dec. 28, 2018

(30) Foreign Application Priority Data
Jan. 3, 2018 (CN) 201810003659.0

(51) Int. Cl. C01B 39/02; B01J 20/18; B01J 20/28; H04R 1/28

(52) U.S. Cl. CPC C01B 39/023; B01J 20/18; B01J 20/2808; C01B 39/14; B01J 20/28016; H04R 1/2876; B01J 20/28083

(57) ABSTRACT

The present disclosure provides a molecular sieve, a sound absorbing material using the molecular sieve, and a speaker. The molecular sieve is a core-shell molecular sieve. The core-shell molecular sieve includes a core phase molecular sieve and a shell layer molecular sieve. The shell layer molecular sieve has a greater average pore diameter than the core phase molecular sieve. The porous shell layer molecular sieve having the greater pore diameter can protect the internal functioning micropores from being blocked, so that a resonant frequency f₀ of a same volume of molecular sieve can be reduced, the bass effect and performance stability are significantly improved.

### CROSS-REFERENCE TO RELATED APPLICATIONS

The present application claims priority to Chinese Patent Application No. 201810003659.0, filed on Jan. 3, 2018, the content of which is incorporated herein by reference in its entirety.

### TECHNICAL FIELD

The present disclosure relates to a molecular sieve and its application, and in particular, to a sound absorbing material based on and apply the core-shell molecular sieve, and an acoustic device.

### BACKGROUND

With a rapid development of portable electronic products such as mobile phones, users' requirements on the functions of products are getting higher and higher, accompanying with an accelerated development of sounding devices. The sounding devices known in the related art includes a housing having a chamber, and a sounding unit accommodated in the housing. Since the chamber is an enclosed structure and has a relatively small volume, the sounding device has a high resonant frequency f₀, which can result in a poor low frequency performance of the sounding device. In this regard, it is challenging to produce sound with high quality, especially a strong bass effect.

In order to obtain high-quality bass effects, in the increasingly thinner and lighter electronic products, it is common to adopt porous materials, such as molecular sieve and porous carbon, to produce the sound absorbing materials.

For example, in representative patent documents such as CN105621436A, CN105032343A, and CN105516880A, a molecular sieve having a certain structure (MFI and FER are most common) is synthesized, and the molecular sieve has a pore diameter between 0.3 and 0.8 nm. Then the molecular sieve is formed in a certain morphology by using an adhesive, and placed into a BOX chamber. When a speaker operates, micropores of the molecular sieve can adsorb and desorb air to enhance an air smoothness, thereby reducing the resonant frequency f₀ and improving the bass effect.

However, the molecular sieve having such a unitary structure has two following distinct disadvantages when being used as a sound absorbing material.

1. The micropores on the surface of the molecular sieves are the main portion to function. Since the powders of the molecular sieve together are required to be bonded by using an adhesive during a forming process, a considerable portion of the micropores on the surface can be blocked by the adhesive. When the speaker operates, only the rest portion of the micropores on the surface adsorb and desorb air, so that reduction of the resonant frequency f₀ and improvement on bass effect are limited.

2. The molecular sieve having a unitary structure tends to absorb moisture in the air or organics volatilized from speaker or other electronic elements, due to its unitary surface property. When the micropores are blocked by the moisture or organics, an entrance or escape of air molecules becomes difficult, which can partially or even totally damage the performances of the molecular sieve. Invalidation of the molecular sieve is disclosed in patent documents such as CN104994461A and CN105049997A.

In view of the above problems, it is necessary to provide a new molecular sieve and a sound absorbing material made thereof, in order to effectively avoid the invalidation and improve sound absorbing effect.

### DESCRIPTION OF EMBODIMENTS

In order to explain objects, features and advantages of the present disclosure, the present disclosure will be described in detail in combination with specific embodiments of the present disclosure.

The present disclosure proposes to use a core-shell molecular sieve as a sound absorbing material of a speaker. The core-shell structure includes a core phase portion and a shell layer portion coated on surface of the core phase portion. The core phase portion and the shell layer portion in the present disclosure both are molecular sieve, and can have a same structure or different structures. The shell layer portion has a greater average pore diameter than the core layer. According to a definition of the International Union of Pure and Applied Chemistry (IUPAC), those having a pore diameter smaller than 2 nm are referred to as “micropores”; those having a pore diameter greater than 50 nm are referred to as “macropores”; and those having a pore diameter between 2 nm and 50 nm are referred to as “mesopores”. In view of this, with respect to the core-shell molecular sieve according to the present disclosure, the core phase molecular sieve is a microporous or mesoporous molecular sieve having a pore diameter between 0.2 μm and 20 μm, and the shell layer molecular sieve has a thickness of 0.001-10 μm, preferably 0.05-1 μm.

The core phase molecular sieve or the shell layer molecular sieve according to the present disclosure has a topological structure of microporous molecular sieve (hereinafter abbreviated as “structure”) selected from the group consisting of MFI, FER, BEA, MOR, MEL, FAU, Linda-A, CHA, AEL, AFI, ATO, and combinations thereof; or a mesoporous molecular sieve including MCM-41, SBA-3, SBA-11, SBA-15, SBA-16, KIT-1, KIT-6, HMS, or mesoporous silica; or combinations of the above microporous molecular sieve; or modified molecular sieve.

### Example 1

A core-shell layer molecular sieve was formed by granulation, in which ZSM-5 (a ratio of silicon to aluminum is 500, MFI structure) is used as a core phase and the core phase has a diameter of 1-5 μm, and MCM-41 is used as a shell layer and the shell layer has a thickness of 0.2-0.5 μm. The core-shell layer molecular sieve was filled in to a 1 mL chamber having a speaker unit, and then the resonant frequency f₀ was measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

### Example 2

A core-shell layer molecular sieve was formed by granulation, in which ZSM-5 (a ratio of silicon to aluminum is 500, MFI structure) is used as a core phase and the core phase has a diameter of 0.7-8 μm, and the mesoporous silica having a two-dimensional hexagonal P6MM structure is used as a shell layer and the shell layer has a thickness of 0.05-0.2 μm. The core-shell layer molecular sieve was filled in to a 1 mL chamber having a speaker unit, and then the resonant frequency f₀ was measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

### Example 3

A core-shell layer molecular sieve was formed by granulation, in which Silicalite-1 (MFI structure) is used as a core phase and the core phase has a diameter of 3-8 μm, and ZSM-5 is used as a shell layer and the shell layer has a thickness of 0.03-0.10 μm. The core-shell layer molecular sieve was filled in to a 1 mL chamber having a speaker unit, and then the resonant frequency f₀ was measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

### Example 4

A core-shell layer molecular sieve was formed by granulation, in which SBA-15 is used as a core phase and the core phase has a diameter of 2-12 μm, and SAPO-34 is used as a shell layer and the shell layer has a thickness of 0.5-1 μm. The core-shell layer molecular sieve was filled in to a 1 mL chamber having a speaker unit, and then the resonant frequency f₀ was measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

### Example 5

A core-shell layer molecular sieve was formed by granulation, in which BEA is used as a core phase and the core phase has a diameter of 1-6 μm, and MCM-41 is used as a shell layer and the shell layer has a thickness of 0.3-0.5 μm. The core-shell layer molecular sieve was filled in to a 1 mL chamber having a speaker unit, and then the resonant frequency f₀ was measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

### Comparative Example 1

A Silicalite-1 pure silicon molecular sieve having a pore diameter of 2-8 μm was formed by granulation. The molecular sieve was filled into a 1 mL chamber having a speaker unit, and then the resonant frequency f₀ is measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

### Comparative Example 2

A ZSM-5 (a ratio of silicon to aluminum is 500) molecular sieve having a pore diameter of 1-5 μm was formed by granulation. The molecular sieve was filled into a 1 mL chamber having a speaker unit, and then the resonant frequency f₀ is measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

### Comparative Example 3

A ZSM-5 (a ratio of silicon to aluminum is 300) molecular sieve having a pore diameter of 1-5 um was formed by granulation. The molecular sieve was filled into a 1 mL chamber having a speaker unit, and then the resonant frequency f₀ was measured. Meanwhile, in order to test the sound absorbing effect of the core-shell layer molecular sieve after adsorbing organics, some particles were placed into a closed space containing toluene/butyl acrylate (in 1:1 volume ratio) and having a relative humidity of 70%-80%. After 2 hours, the particles were taken out and loaded into the 1 mL chamber having the speaker unit to measure the resonant frequency f₀.

The measurement results of Examples 1-5 and Comparative Examples 1-3 are shown in Table 1.

TABLE 1

| | | | | formed particles that | |
|---|---|---|---|---|---|
| | | | | have adsorbed | |
| | | | | moisture and organics | |
| | | | | | reduced |
| | | | | | value of |
| | | | | f₀ (Hz), | f₀ (Hz), |
| | | formed particles | | after filling | after filling |
| products | | f₀ (Hz), | reduced | with sample | with sample |
| | f₀ (Hz), | after filling | value | that has | that has |
| | empty | with sample | of f₀ | adsorbed | adsorbed |
| Sample | chamber | (Hz) | (Hz) | for 2 hours | for 2 hours |
| Comparative | 879 | 618 | 261 | 870 | 7 |
| Example 1 | | | | | |
| Comparative | 877 | 639 | 238 | 678 | 199 |
| Example 2 | | | | | |
| Comparative | 878 | 651 | 227 | 723 | 155 |
| Example 3 | | | | | |
| Example 1 | 877 | 590 | 287 | 618 | 259 |
| Example 2 | 880 | 598 | 282 | 615 | 265 |
| Example 3 | 877 | 640 | 237 | 665 | 212 |
| Example 4 | 878 | 650 | 228 | 663 | 215 |
| Example 5 | 878 | 680 | 198 | 690 | 188 |

It can be seen from Table 1 that, by using the core-shell molecular sieve according to the present disclosure as a sound absorbing material, the initially formed core-shell molecular sieves each have a reduced resonant frequency f₀ when compared with the conventional molecular sieves. However, the difference of the resonant frequencies f₀ between the two kinds of molecular sieves is not significant. As regards the values of the resonant frequency f₀ that are measured after adsorbing moisture or organics, the resonant frequency f₀ of the core-shell layer molecular sieve is significantly reduced, while the conventional microporous molecular sieve has a significantly weakened ability of adsorbing or desorbing air. It can be seen that the multiple surface layers of the core-shell molecular sieve have a significant protective effect on the internal micropores.

On the one hand, by providing a layer of porous molecular sieve having different properties and a greater pore diameter on the surface of the functioning microporous molecular sieve, the functioning internal micropores can be protected from being blocked.

On the other hand, the surface layer can adsorb water vapor or organics, but has insignificant influence on the mobility of air in the internal micropores of the inner layer due to its greater pore diameter, thereby reducing the resonant frequency f₀, and improving the bass effect and performance stability.

The core-shell molecular sieve provided in the present disclosure can be used to a sound absorbing material, and is suitable for a conventional sounding device such as a speaker.

The above description is merely related to the preferred embodiments of the present disclosure. It should be understood that modifications made by those skilled in the art without departing from the inventive concept of the present disclosure shall fall into the protection scope of the present disclosure.

What is claimed is:

1. A molecular sieve, being a core-shell molecular sieve comprising:
a core phase molecular sieve; and
a shell layer molecular sieve,
wherein the shell layer molecular sieve has a greater average pore diameter than the core phase molecular sieve.

2. The molecular sieve as described in claim 1, wherein the core phase molecular sieve and the shell layer molecular sieve have a same structure or different structures.

3. The molecular sieve as described in claim 2, wherein the core phase molecular sieve has a diameter of 0.2 μm to 20 μm, and the shell layer molecular sieve has a thickness of 0.001 μm to 10 μm.

4. The molecular sieve as described in claim 1, wherein the core phase molecular sieve and/or the shell layer molecular sieve comprise a microporous molecular sieve, a mesoporous molecular sieve, or a combination thereof.

5. The molecular sieve as described in claim 2, wherein the core phase molecular sieve and/or the shell layer molecular sieve comprise a microporous molecular sieve, a mesoporous molecular sieve, or a combination thereof.

6. The molecular sieve as described in claim 4, wherein the microporous molecular sieve comprises a topological structure selected from a group consisting of MFI, FER, BEA, MOR, MEL, FAU, Linda-A, CHA, AEL, AFI, ATO, and combinations thereof.

7. The molecular sieve as described in claim 4, the mesoporous molecular sieve is selected from a group consisting of MCM-41, SBA-3, SBA-15, SBA-16, KIT-6, and combinations thereof.

8. The molecular sieve as described in claim 4, the shell layer molecular sieve comprises a mesoporous molecular sieve selected from a group consisting of SBA-11, HMS, KIT-1, mesoporous silica, and combinations thereof.

9. A sound absorbing material, comprising the molecular sieve according to claim 1.

10. A speaker, comprising the sound absorbing material according to claim 9.
